(19) United States
(12) Patent Application Publication
(10) Pub. No.: US 2011/0273103 A1
(43) Pub. Date: Nov. 10, 2011

(54) LED LAMP WITH ADJUSTABLE ILLUMINATION INTENSITY BASED ON AC VOLTAGE AMPLITUDE

(75) Inventor: Soon Won HONG, Seoul (KR)

(73) Assignee: TLI Inc., Gyeonggi-do (KR)

(21) Appl. No.: 13/093,393

(22) Filed: Apr. 25, 2011

(30) Foreign Application Priority Data
May 6, 2010 (KR) 10-2010-0042319

(51) Int. Cl. H05B 37/00

(52) U.S. Cl. 315/193

(57) ABSTRACT

An LED lamp with adjustable illumination intensity is disclosed. The LED lamp comprises an illumination block having first, second, and third illumination modules, and first and second switches. The first, second, and third illumination modules are coupled in series between a rectification voltage node and a third connection node. The first switch selectively connects a first connection node shared by the first and second illumination modules to a basis voltage node. The second switch selectively connects a second connection node shared by the second and third illumination modules to the basis voltage node. The third connection node is coupled to the basis voltage node. A control block provides the first and second control signals respectively controlling the first and second switches, wherein the logic states of the first and second control signals are based on the amplitude of a driving voltage measured between the rectification and basis voltage nodes.

### CROSS-REFERENCE TO RELATED APPLICATION

This application claims the benefit of Korean Patent Application No. 10-2010-0042319, filed on May 6, 2010, the contents of which are hereby incorporated herein by reference in their entirety.

### BACKGROUND

1. Field

The present invention relates to a lamp, and more particularly, to an LED (Light Emitting Diode) lamp including a plurality of LED elements which are selectively activated or de-activated based on the amplitude of a source voltage received by the LED lamp.

2. Description of the Related Art

Generally, an LED lamp includes a plurality of LED elements which are serially connected to each other. Each of the LED elements is powered by a voltage applied thereto, and produces illumination in response to the applied voltage. The LED lamp has many advantages including small size, long lifetime and high efficiency. LED lamps have therefore been predicted to gradually replace incandescent lamps and fluorescent lamps for many lighting applications, including use in ambient lighting in residential, commercial, and industrial applications, use in headlights, as well as other lighting applications.

The LED element is very sensitive to the voltage applied across its terminals. For example, when the applied voltage is excessively high, the current in the LED element is very large and the LED element may become deteriorated or damaged. Meanwhile, when the applied voltage is lower than a boundary voltage, the current flowing through the LED element is very small and the LED element may produce little or no light. Therefore, it is very important to control the voltage which is applied across the LED element to avoid damage and produce sufficient lighting intensity.

FIG. 1 shows a conventional LED lamp. The conventional LED lamp has an alternating voltage supplier 10, a bridge diode 20 and an illumination block 30. The alternating voltage supplier 10 supplies an alternating voltage VAC. The bridge diode 20 generates a rectification voltage VREC by rectifying the alternating voltage VAC. And, the LED elements of illumination block 30 are coupled in series and are illuminated by the rectification voltage VREC applied across their terminals.

However, in the conventional LED lamp, when the amplitude of the rectification voltage is lower than a reference voltage, the lighting intensity produced by the LED elements becomes very low. If the rectification voltage is very low, all of the LED elements may be extinguished.

### SUMMARY OF THE INVENTION

According to an aspect of the present invention, there is provided an LED lamp. The LED lamp comprises a rectification block providing a driving voltage between a rectification voltage node and a basis voltage node; an illumination block comprising a first illumination module, a second illumination module, a third illumination module, a first connection switch and a second connection switch, wherein the first illumination module is coupled between the rectification voltage node and a first connection node, the second illumination module is coupled between the first connection node and a second connection node, and the third illumination module is coupled between the second connection node and a third connection node, wherein the first connection switch is configured to selectively electrically connect the first connection node to the basis voltage node in response to the activation of a first control signal, the second connection switch is configured to selectively electrically connect the second connection node to the basis voltage node in response to the activation of a second control signal, and the third connection node is capable of being coupled to the basis voltage node; and a control block providing the first control signal and the second control signal, wherein the logic states of the first control signal and the second control signal are dependent on the amplitude of the driving voltage.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain aspects of the invention.

FIG. 1 shows a conventional LED lamp;

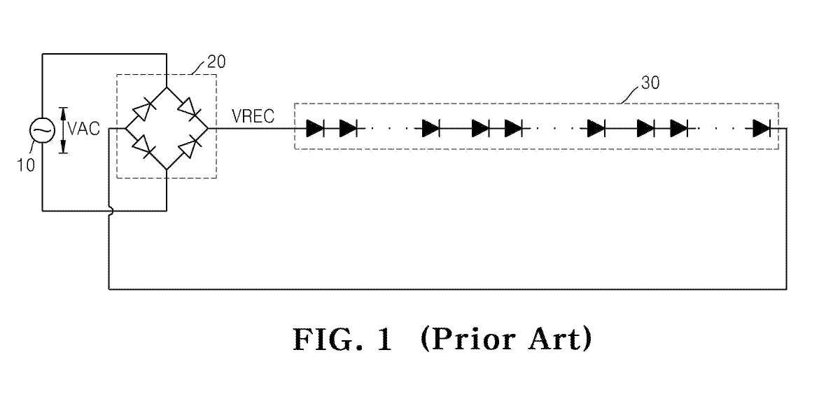

FIG. 2 is a drawing of an LED lamp according to a first embodiment of the present invention;

FIG. 3 is a drawing for explaining the rectification of an alternating voltage;

FIG. 4 is a simulation drawing for explaining an illuminating amount in the LED lamp of FIG. 2; and

FIG. 5 is a drawing of a LED lamp according to a second embodiment of the present invention.

### DETAILED DESCRIPTION OF EMBODIMENTS

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “coupled to” another element, it can be directly coupled to the other element or intervening elements may be present therebetween. In contrast, when an element is referred to as being “directly coupled to” another element, there are no intervening elements present.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

### First Embodiment

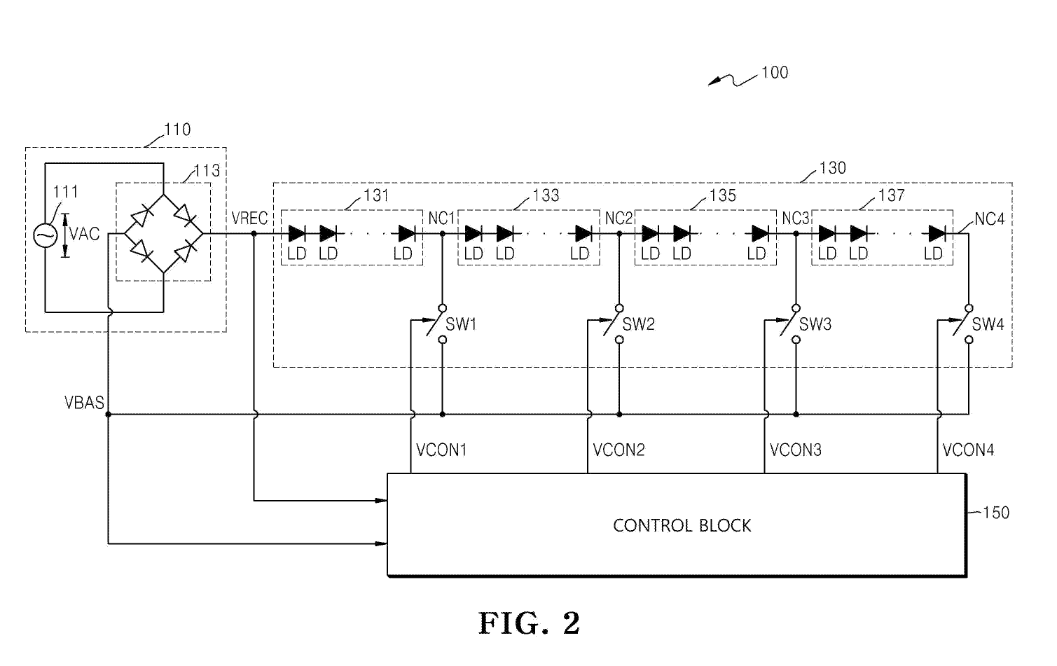

FIG. 2 is a drawing of an LED lamp 100 according to the first embodiment of the present invention. Referring again to FIG. 2, the LED lamp 100 comprises a rectification block 110, an illumination block 130 and a control block 150.

The rectification block 110 provides a rectification voltage VREC at its VREC output node, a basis voltage VBAS at its VBAS output node, and a driving voltage difference VLU between its VREC and VBAS output nodes. Herein, the driving voltage difference VLU is the directional voltage difference between the rectification voltage VREC and the basis voltage VBAS: V_{VLU}=V_{REC}−V_{BAS}. In this embodiment, the driving voltage difference VLU is time-varying.

Preferably, the rectification block 110 includes an alternating voltage source 111 and a rectifier 113. The alternating voltage source 111 supplies an alternating voltage VAC across its terminals. The rectifier 113 receives the alternating voltage VAC across its input nodes, and provides at its output node VREC the rectification voltage VREC by rectifying the alternating voltage VAC. Also, the rectifier 113 provides at its output node VBAS the basis voltage VBAS, which is nearly a ground voltage VSS.

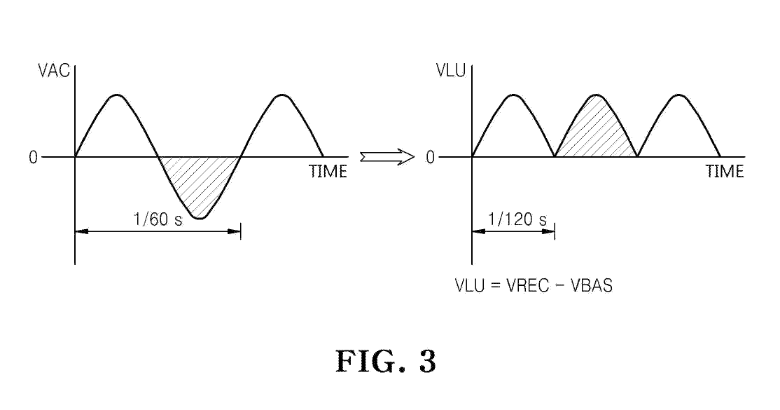

Preferably, the rectifier 113 is a full-wave rectifier and rectifies the alternating voltage VAC in full range, as shown in FIG. 3. With a full-wave rectifier 113, the negative voltage level in the alternating voltage VAC is converted into a positive voltage level in the rectification voltage VREC.

The rectifier 113 may be implemented using a bridge diode, which comprises four diodes. Other rectifier architectures, including half-wave rectifiers, rectifiers including output smoothing, rectifiers including one or more capacitors coupled across their input nodes or output nodes, may also be used as rectifier 113.

Referring again to FIG. 2, the illumination block 130 includes multiple LED elements LDs connected in series. The LED elements LDs may be powered by the rectification voltage VREC. The control block 150 controls the illumination block 130, so that the number of LED elements LDs which are powered is dependent on the driving voltage difference VLU.

The illumination block 130 and the control block 150 are described in more detail below.

The illumination block 130 has a first illumination module 131, a second illumination module 133, a third illumination module 135 and a fourth illumination module 137.

The first to the fourth illumination modules 131 to 137 are serially connected between the rectification voltage node VREC and the basis voltage node VBAS. In each of the first to the fourth illumination modules 131 to 137, one or more LED elements LDs are included; in embodiments in which one or more illumination modules 131 to 137 include a plurality of LED elements LDs, the LED elements LDs are coupled in series.

In this embodiment, the first illumination module 131 is connected between the rectification voltage node VREC and a first connection node NC1, and the second illumination module 133 is connected between the first connection node NC1 and a second connection node NC2. The third illumination module 135 is connected between the second connection node NC2 and a third connection node NC3, and the fourth illumination module 137 is connected between the third connection node NC3 and the fourth connection node NC4.

Also, the illumination block 130 has first through fourth connection switches SW1, SW2, SW3 and SW4.

The first connection switch SW1 is controlled to selectively electrically connect the first connection node NC1 to the basis voltage node VBAS in response to the activation of a first control signal VCON1. The second connection switch SW2 is controlled to selectively electrically connect the second connection node NC2 to the basis voltage node VBAS in response to the activation of a second control signal VCON2. The third connection switch SW3 is controlled to selectively electrically connect the third connection node NC3 to the basis voltage node VBAS in response to the activation of a third control signal VCON3. And, the fourth connection switch SW4 is controlled to selectively electrically connect the fourth connection node NC4 to the basis voltage node VBAS in response to the activation of a fourth control signal VCON4.

The control block 150 detects the instantaneous value or amplitude of the driving voltage difference VLU, and generates the first to the fourth control signals VCON1 to VCON4 based on the detected value of the driving voltage difference VLU. The logic states of the first to the fourth control signals VCON1 to VCON4 are dependent on the value of the driving voltage difference VLU.

(Table 1) shows an example in which the logic states of the first to the fourth control signals VCON1 to VCON4 are selected according to the instantaneous value of the driving voltage difference VLU.

TABLE 1

| | I | II | III | IV |
|---|---|---|---|---|
| | VLU ≦ | 0.25 Vp < VLU ≦ | 0.5 Vp < VLU ≦ | 0.75 Vp < |
| | 0.25 Vp | 0.5 Vp | 0.75 Vp | VLU |
| VCON1 | H | L | L | L |
| VCON2 | L | H | L | L |
| VCON3 | L | L | H | L |
| VCON4 | L | L | L | H |

In Table 1, Vp refers to the maximum voltage amplitude of the driving voltage difference VLU in the ideal case. In the exemplary embodiment of Table 1, 0.25 Vp, 0.5 Vp and 0.75 Vp are first to third boundary voltages used in the embodiment as threshold voltages for selectively activating the control signals VCON1 to VCON4; however, in other embodiments, other values of boundary voltages may be used.

According to Table 1, if during a period I the amplitude of the driving voltage difference VLU is no more than 0.25 Vp, the first control signal VCON1 is in the logic “H” state and the first connection switch SW1 is turned on (i.e., switch SW1 is conducting and electrically connects node NC1 to node VBAS). In this case, the first illumination module 131 is powered and produces illumination, but the second to the fourth illumination modules 133, 135 and 137 are not powered and do not produce illumination.

In a period II, if the driving voltage difference VLU is over 0.25 Vp and no more than 0.5 Vp, the second control signal VCON2 is in the logic “H” state and the second connection switch SW2 is turned on. In this case, the first and the second illumination modules 131 and 133 are powered and produce illumination, but the third and the fourth illumination modules 135 and 137 are not powered and do not produce illumination.

In a period III, if the driving voltage difference VLU is over 0.5 Vp and no more than 0.75 Vp, the third control signal VCON3 is in the logic “H” state and the third connection switch SW3 is turned on. In this case, the first to the third illumination modules 131, 133 and 135 are powered and produce illumination, but the fourth illumination module 137 is not powered and does not produce illumination.

In a period IV, the driving voltage difference VLU is over 0.75 Vp, the fourth control signal VCON4 is in the logic “H” state, and the fourth connection switch SW4 is turned on. In this case, all of the first to the fourth illumination modules 131 to 137 are powered and produce illumination.

In this embodiment, the number of illumination modules which are powered and produce illumination is dependent on the value of the driving voltage difference VLU. That is, the number of LED elements which are powered and illuminated is dependent on the driving voltage difference VLU.

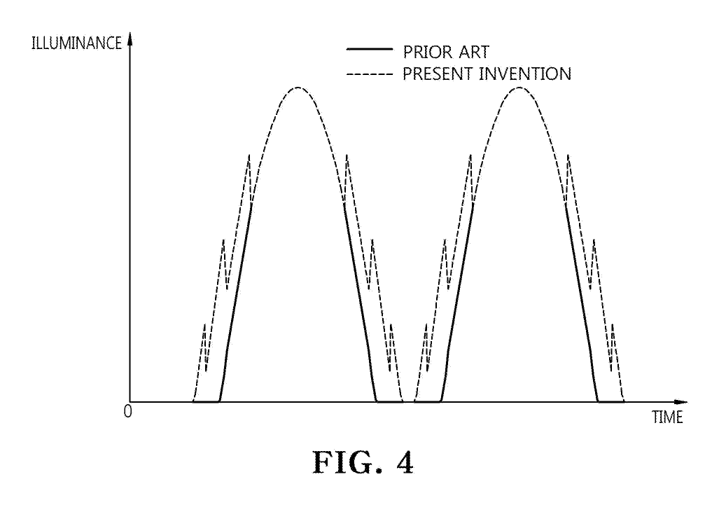

Therefore, in the LED lamp of FIG. 2, the lighting intensity produced by illumination block 130 is variably adjusted based on the instantaneous amplitude of the driving voltage such that the total lighting intensity is remarkably increased, as shown in FIG. 4. Also, the length of the period of time during which none of the LED elements are powered and producing illumination (i.e., producing zero illuminance) is remarkably reduced. Finally, the illumination blocks of the LED lamp are selectively activated and de-activated several times during each period of the driving voltage period based on the amplitude of the driving voltage at each instant.

As a result, according to the LED lamp of FIG. 2, the characteristics such as the power factor and the crest factor are improved.

In an alternative embodiment, the last connection node in the illumination block can be directly connected to the basis voltage VBAS without an intervening corresponding connection switch. In the embodiment of FIG. 2, the fourth connection node NC4 can be directly connected to the basis voltage node VBAS without passing through the fourth switch SW4. In this case, the fourth switch SW4 is not necessary and the control block 150 does not need to provide the fourth control signal VCON4. In an other exemplary embodiment in which only the first to the third LED modules 131 to 135 are coupled in series between the rectification voltage node VREC and the basis voltage node VBAS, the third connection node NC3 can be directly connected to the basis voltage node VBAS without passing through the third switch SW3.

### Second Embodiment

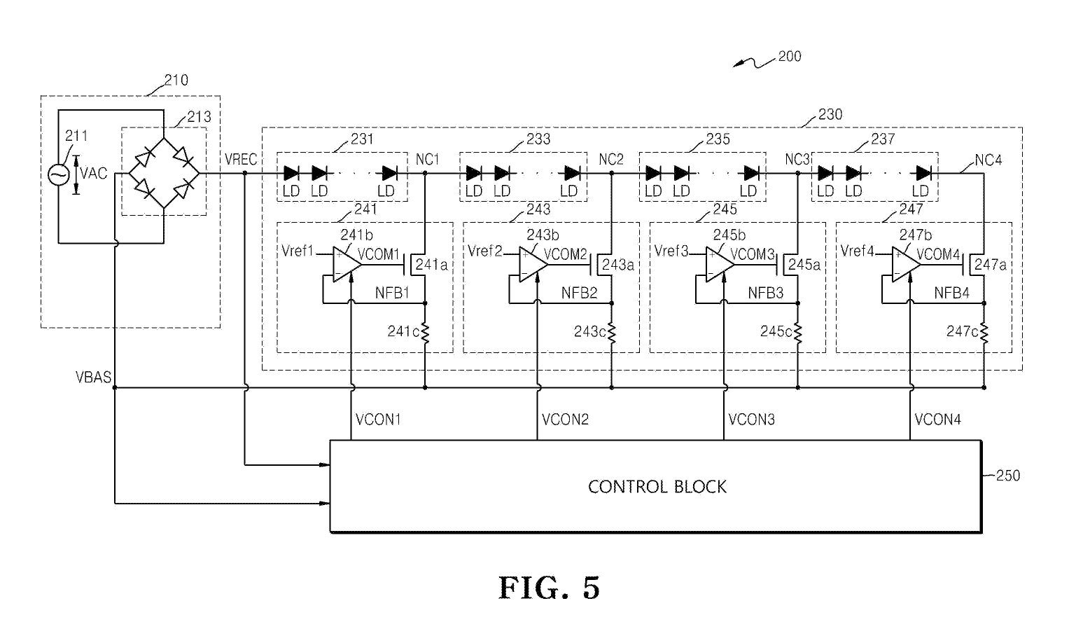

FIG. 5 is a drawing of an LED lamp 200 according to the second embodiment of the present invention. Referring again to FIG. 5, the LED lamp 200 comprises a rectification block 210, an illumination block 230 and a control block 250.

The rectification block 210 provides a rectification voltage VREC at its VREC output node, a basis voltage VBAS at its VBAS output node, and a driving voltage difference VLU between its VREC and VBAS output nodes.

Preferably, the rectification block 210 includes an alternating voltage source 211 and a rectifier 213. The alternating voltage source 211 supplies an alternating voltage VAC across its terminals. The rectifier 213 receives the alternating voltage VAC across its input nodes, and provides the rectification voltage VREC by rectifying the alternating voltage VAC.

The illumination block 230 has a first illumination module 231, a second illumination module 233, a third illumination module 235 and a fourth illumination module 237. The first to the fourth illumination module 231 to 237 are serially connected between the rectification voltage node VREC and the basis voltage node VBAS. In alternative embodiments, fewer illumination modules may be included; in other embodiments, additional illumination modules may be serially connected between the VREC and VBAS nodes.

In this embodiment, the first illumination module 231 is coupled between the rectification voltage node VREC and a first connection node NC1, and the second illumination module 233 is coupled between the first connection node NC1 and a second connection node NC2. The third illumination module 235 is coupled between the second connection node NC2 and a third connection node NC3, and the fourth illumination module 237 is coupled between the third connection node NC3 and the fourth connection node NC4.

The illumination block 230 has first to fourth connecting portions 241 to 247.

The first connecting portion 241 is controlled to selectively electrically connect the first connection node NC1 to the basis voltage node VBAS in response to the activation of a first control signal VCON1. The second connecting portion 242 is controlled to selectively electrically connect the second connection node NC2 to the basis voltage node VBAS in response to the activation of a second control signal VCON2. The third connecting portion 243 is controlled to selectively electrically connect the third connection node NC3 to the basis voltage node VBAS in response to the activation of a third control signal VCON3. And, the fourth connecting portion 244 is controlled to selectively electrically connect the fourth connection node NC4 to the basis voltage node VBAS in response to the activation of a fourth control signal VCON4.

The control block 250 detects the instantaneous value or amplitude of the driving voltage difference VLU, and generates the first to the fourth control signals VCON1 to VCON4 based on the detected value of the driving voltage difference VLU. The logic states of the first to the fourth control signals VCON1 to VCON4 are dependent on the value of the driving voltage difference VLU.

In this embodiment, the number of illumination modules which receive power and produce illumination is dependent on the value of the driving voltage difference VLU.

Each of the first to the fourth connecting portions 241 to 247 are operative to form a closed current loop by electrically connecting the corresponding connection node to the basis voltage node VBAS. Also, the first to the fourth connecting portions 241 to 247 control the current flowing through the LED modules enclosed in the closed current loop, so that excessive current in the LED modules is reduced.

In particular, the first connecting portion 241 is driven to control the current in the first illumination module 231. The second connecting portion 243 is driven to control the current in the first illumination module 231 and the second illumination module 233. The third connecting portion 245 is driven to control the current in the first to the third illumination modules 231 to 235. And, the fourth connecting portion 247 is driven to control the current in the first to the fourth illumination modules 231 to 237.

Due to the first to the fourth connecting portions 241 to 247, excessive current flow through each of the first to the fourth illumination modules 231 to 237 may be reduced.

The first to the fourth connecting portions 241 to 247 are very similar to each other. So, the third connecting portion 245 is representatively described in this specification.

The third connecting portion 245 includes a third switching element 245a, a third comparing element 245b and a third resistor 245c. The third switching element 245a is coupled between the third connection node NC3 and a third feedback node NFB3. The third switching element 245a may be an NMOS transistor having a gate terminal gated with a third compare signal VCOM3, a source terminal connected to the third feedback node NFB3, and a drain terminal connected to the third connecting node NC3. The third switching element 245a connects the third connection node NC3 to the third feedback node NFB3 with a switching conductance dependent on the voltage of the third compare signal VCOM3. That is to say, the conductance in the third switching element 245a is controlled by the voltage level in the third compare signal VCOM3.

The third comparing element 245b compares the voltage of the third feedback node NFB3 with a third reference voltage Vref3 to generate the third compare signal VCOM3. At this time, the voltage in the third compare signal VCOM3 is decreased as the voltage in the third feedback node NFB3 is increased (i.e., the third feedback node NFB3 is coupled to an inverting input of comparing element 245b).

The third resistor 245c connects the third feedback node NFB3 to the basis voltage node VBAS.

Preferably, first to fourth reference voltages Vref1 to Vref4 are the same. However, in some embodiments, each of the first to fourth references voltages Vref1 to Vref4 may have different amplitudes or variable values.

A method for reducing excessive current flow through the LED modules using the circuitry of LED lamp 200 will now be described.

When the amplitude of alternating voltage VAC is excessively high, LED modules in the closed current loop may be subject to excessive current flow. As a result of the high current flow, the voltage in the feedback nodes NFB1 to NFB4 is increased, and the voltage level of the compare signals VCOM1 to VCOM4 is decreased. As a result of the increase in the voltage level in feedback nodes NFB1 to NFB4 and of the decrease in the voltage level in compare signals VCOM1 to VCOM4, the resistance in the switching elements 241a to 247a is increased, and current flow through the LED modules included in the closed current loop becomes reduced.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

What is claimed is:

1. An LED lamp, comprising:
a rectification block providing a driving voltage between a rectification voltage node and a basis voltage node;
an illumination block comprising:
a first illumination module,
a second illumination module,
a third illumination module,
a first connection switch, and
a second connection switch,
wherein the first illumination module is coupled between the rectification voltage node and a first connection node, the second illumination module is coupled between the first connection node and a second connection node, and the third illumination module is coupled between the second connection node and a third connection node,
wherein the first connection switch is configured to selectively electrically connect the first connection node to the basis voltage node in response to the activation of a first control signal, the second connection switch is configured to selectively electrically connect the second connection node to the basis voltage node in response to the activation of a second control signal, and the third connection node is capable of being coupled to the basis voltage node; and
a control block providing the first control signal and the second control signal,
wherein the logic states of the first control signal and the second control signal are based on the amplitude of the driving voltage.

2. The LED lamp of claim 1, wherein the illumination block further comprises:
a third connection switch selectively electrically coupling the third connection node to the basis voltage node in response to the activation of a third control signal,
wherein the control block further provides the third control signal, the third control signal being activated according to the amplitude of the driving voltage.

3. The LED lamp of claim 1, wherein each of the first, second, and third illumination modules comprises a plurality of light emitting diodes coupled in series.

4. The LED lamp of claim 1, wherein:
the first control signal is HIGH when the amplitude of the driving voltage is below a first threshold value V1,
the first control signal is LOW and the second control signal is HIGH when the amplitude of the driving voltage is higher than the first threshold value V1 and below a second threshold value V2,
the first and second control signals are LOW when the amplitude of the driving voltage is higher than the second threshold value V2, and
the first and second threshold values are such that V1≦V2.

5. The LED lamp of claim 1,
wherein the rectification block comprises:
an alternating voltage source supplying an alternating voltage across its output, the alternating voltage having a period; and
a rectifier coupled to the output of the alternating voltage source and producing the driving voltage between the rectification and basis voltage nodes, and
wherein the control block adjusts the first control signal and the second control signal multiple times per period based on the instantaneous value of the driving voltage.

6. An LED lamp, comprising:
a rectification block providing a driving voltage between a rectification voltage node and a basis voltage node;
an illumination block comprising:
a first illumination module,
a second illumination module,
a first connecting portion, and
a second connecting portion,
wherein the first illumination module is coupled between the rectification voltage node and a first connection node, and the second illumination module is coupled between the first connection node and a second connection node,
wherein the first connecting portion is operative to electrically connect the first connection node to the basis voltage node in response to the activation of a first control signal, and the second connecting portion is operative to electrically connect the second connection node to the basis voltage node in response to the activation of a second control signal; and
a control block providing the first control signal and the second control signal, wherein the logic states of the first control signal and the second control signal are dependent on the amplitude of the driving voltage,
wherein the first connecting portion comprises:
a switching element operative to connect the first connection node to a feedback node with an adjustable switching conductance dependent on the voltage of a compare signal;
a comparing element comparing the voltage of the feedback node with a reference voltage to generate the compare signal; and
a resistor coupled between the feedback node and the basis voltage node.

7. The LED lamp of claim 6, wherein the switching element comprises:
an NMOS transistor having a gate terminal receiving the compare signal generated by the comparing element, a source terminal connected to the feedback node, and a drain terminal connected to the first connection node.

8. The LED lamp of claim 6, wherein each of the first and second illumination modules comprises a plurality of light emitting diodes coupled in series.

9. The LED lamp of claim 6, wherein:
the first control signal is HIGH when the amplitude of the driving voltage is below a first threshold value V1,
the first control signal is LOW and the second control signal is HIGH when the amplitude of the driving voltage is higher than the first threshold value V1 and below a second threshold value V2,
the first and second control signals are LOW when the amplitude of the driving voltage is higher than the second threshold value V2, and
the first and second threshold values are such that V1≦V2.

10. The LED lamp of claim 6,
wherein the rectification block comprises:
an alternating voltage source supplying an alternating voltage across its output, the alternating voltage having a period; and
a rectifier coupled to the output of the alternating voltage source and producing the driving voltage between the rectification and basis voltage nodes, and
wherein the control block adjusts the first control signal and the second control signal multiple times per period based on the instantaneous value of the driving voltage.

11. An LED lamp receiving a supply voltage with a variable amplitude across first and second input terminals, the LED lamp comprising:
a first illumination block comprising a plurality of diodes coupled in series and coupled between the first input terminal and a first connection node;
a second illumination block comprising a plurality of diodes coupled in series and coupled between the first connection node and a second connection node;
a third illumination block comprising a plurality of diodes coupled in series and coupled between the second connection node and a third connection node;
a first connection switch operative to selectively couple the first connection node to the second input terminal in response to a first control signal;
a second connection switch operative to selectively couple the second connection node to the second input terminal in response to a second control signal;
a third connection switch operative to selectively couple the third connection node to the second input terminal in response to a third control signal; and
a control block having inputs coupled to the first and second input terminals and outputs coupled to the first, second, and third connection switches, the control block producing the first, second, and third control signals in response to the amplitude of the voltage across the first and second input terminals.

12. The LED lamp of claim 11, further comprising:
a fourth illumination block comprising a plurality of diodes coupled in series and coupled between the third connection node and the second input terminal.

13. The LED lamp of claim 12, wherein the control block produces the first, second, and third control signals such that the first control signal is HIGH when the amplitude of the driving voltage is below a first threshold value V1, the first control signal is LOW and the second control signal is HIGH when the amplitude of the driving voltage is higher than the first threshold value V1 and below a second threshold value V2, the first and second control signals are LOW and the third control signal is HIGH when the amplitude of the driving voltage is higher than the second threshold value V2 and below a third threshold value V3, and the first, second, and third control signals are LOW when the amplitude of the driving voltage is higher than the third threshold value V3,
wherein the first, second, and third threshold values are such that V1≦V2≦V3.
